(19) United States
(12) Patent Application Publication
(10) Pub. No.: US 2013/0039030 A1
(43) Pub. Date: Feb. 14, 2013

(54) LIGHT IRRADIATION APPARATUS

(71) Applicants: Noboru KUNIMATSU, Chiba (JP); Yasushi TOMIOKA, Hitachinaka (JP); Hidehiro SONODA, Mobara (JP)

(72) Inventors: Noboru KUNIMATSU, Chiba (JP); Yasushi TOMIOKA, Hitachinaka (JP); Hidehiro SONODA, Mobara (JP)

(73) Assignee: Japan Display East Inc.

(21) Appl. No.: 13/569,339

(22) Filed: Aug. 8, 2012

(30) Foreign Application Priority Data
Aug. 8, 2011 (JP) 2011-172610

(51) Int. Cl. F21V 7/00; F21V 13/14; F21V 13/04; F21V 7/06; F21V 9/14

(52) U.S. Cl. 362/19; 362/217.07; 362/217.06; 362/217.05

(57) ABSTRACT

By narrowing the length of an irradiation area, a scan distance is shortened and a process time of a light irradiation process is shortened. A light irradiation apparatus irradiating light to a substrate by using a long arc lamp includes: a reflection mirror having a cross-sectional shape which is an oval or parabolic shape and having a shape as if light irradiated is condensed on the surface of the substrate; and a slit limiting an irradiation area of the irradiated light, wherein on a section perpendicular to a long axis of the long arc lamp, a main irradiation area length X and a gap H between the long arc lamp and the substrate satisfy a relationship of X<0.087H.

### CLAIM OF PRIORITY

The present application claims priority from Japanese patent application JP2011-172610 filed on Aug. 8, 2011, the content of which is hereby incorporated by reference into this application.

### BACKGROUND OF THE INVENTION

1. Field of the Invention

The present invention relates to a light irradiation apparatus for manufacturing a photo-alignment film of a liquid crystal panel or a phase difference film and a light irradiation apparatus for manufacturing a color filter or a TFT of the liquid crystal panel, and particularly, to a light irradiation apparatus shortening a process time of an irradiation process.

2. Description of the Related Art

In a liquid crystal display device, as a processing method for allocating an alignment function to an alignment film, a photo-alignment method is proposed. In the photo-alignment method, a polarization-direction polymer chain is selectively reacted by irradiating linearly polarized ultraviolet rays (polarized UV light) onto a polymer film such as polyimide, and the like, such that anisotropy is generated in a molecular array of the polymer film to give liquid crystal alignment performance.

In manufacturing the alignment film by the photo-alignment method, a light source generating the polarized UV light and an unaligned polymer film are relatively moved (scanned) to perform polarized exposure.

Japanese Patent No. 3946441 discloses “an optical exposure system for aligning a substrate with partially polarized and partially collimated light that includes: at least one source of optical radiation; means for partially collimating the optical radiation; means for partially polarizing the optical radiation in which a polarization ratio of the partially polarized optical radiation is in the range of 1:00 to 100:1 except for a state of approximately 1:1; and means for transporting the substrate relative to the partially collimated and polarized optical radiation in which the partially polarized optical radiation of which a divergent angle depending on one dimension is approximately 5° or more and approximately 30° or less and a divergent angle depending on a dimension perpendicular to one dimension is not limited” in claim 1.

### SUMMARY OF THE INVENTION

An optical system of a light irradiation apparatus based on the related art is illustrated in FIG. 5. Ultraviolet rays generated from a long arc lamp 1 are condensed on a reflection mirror 2 and linearly polarized by a polarizer 3, and the width of the ultraviolet rays is controlled by a slit 4 to be irradiated onto a substrate 5 with an unaligned polymer film (base). In Japanese Patent No. 3946441, since a divergent angle depending on one dimension is approximately 5° or more and further, approximately 30° or less, an angle θ of FIG. 5 is a half thereof, 2.5°≦θ≦15°.

θ is an angle at which a light source is viewed through an end of an opening of the slit 4 when viewed up from the substrate.

As illustrated in FIG. 5, when a distance between the light source and the substrate is set as H and the length of a scan-direction main irradiation area is set as X, a range of X for H is 0.087H≦X≦0.536H from a relationship of tan θ=(X/2)/H.

FIG. 6 illustrates a state in which the long arc lamp 1 is fixed and the substrate 5 with the base is moved to perform scan irradiation. An upper figure illustrates a state in which irradiation starts, a middle figure illustrates a state under irradiation, and a lower figure illustrates a state in which irradiation ends. When the length of the substrate is set as L, the length of a main irradiation area of the light irradiation apparatus is set as X, the length of a reflection light irradiation area in which not directly irradiated light from the lamp but only the reflection light from the reflection mirror is irradiated is set as Z, and a scan velocity of the substrate is set as V (constant),

Scan distance=substrate length (L)+main irradiation area length (X)+reflection light irradiation area length (Z)×2, and

Irradiation time (T)=scan distance/scan velocity=(L+X+2Z)/V.

In the related art, since the main irradiation area length X is large, a shift distance of the substrate in a light irradiation process is long and a time for which light is irradiated to the substrate is lengthened, and as a result, a process time is lengthened. That is, a throughput of production is lowered.

An object of the present invention is to shorten the scan distance and shorten the process time of the light irradiation process by decreasing the irradiation area length in the light irradiation apparatus.

In order to address the above the problems, according to an aspect of the present invention, there is provided a light irradiation apparatus irradiating light to a substrate by using a long arc lamp, including: a reflection mirror having a cross-sectional shape which is an oval or parabolic shape and having a shape as if light irradiated is condensed on the surface of the substrate; and a slit limiting an irradiation area of the irradiated light, wherein on a section perpendicular to a long axis of the long arc lamp, a main irradiation area length X and a gap H between the long arc lamp and the substrate satisfy a relationship of X<0.087H, and a gap h between the slit and the substrate satisfies a relationship of h<XHH′/((6H−5H′)X+5HY when a scan-direction length of the opening end of the reflection mirror is set as Y and the a gap between the opening end of the reflection mirror and the substrate is set as H′.

According to another aspect of the present invention, there is provided a light irradiation apparatus irradiating light to a substrate by using a long arc lamp, including: a reflection mirror substantially controlling an irradiation direction of a light source; and lateral reflection mirrors placed between a substrate-side section of the reflection mirror and the substrate, wherein on a section perpendicular to a long axis of the long arc lamp, a main irradiation area length X and a gap H between the long arc lamp and the substrate satisfy a relationship of X<0.087H.

According to yet another aspect of the present invention, there is provided a light irradiation apparatus irradiating light to a substrate by using a long arc lamp, including: a reflection mirror substantially controlling an irradiation direction of a light source; a mirror slit installed on a substrate-side section of the reflection mirror and passing the light by an opening while reflecting the light; and a slit limiting an irradiation area of the irradiated light, wherein on a section perpendicular to a long axis of the long arc lamp, a main irradiation area length X and a gap H between the long arc lamp and the substrate satisfy a relationship of X<0.087H.

According to still another aspect of the present invention, there is provided a light irradiation apparatus irradiating light to a substrate by using a long arc lamp, including: a reflection mirror substantially controlling an irradiation direction of a light source; a cylindrical lens collimating light on a section perpendicular to a long axis of the long arc lamp; and a slit limiting an irradiation area of the irradiated light, wherein on a section perpendicular to a long axis of the long arc lamp, a main irradiation area length X and a gap H between the long arc lamp and the substrate satisfy a relationship of X<0.087H.

According to aspects of the present invention, in manufacturing the photo-alignment film, and the like, the process time of the light irradiation process can be shortened and the throughput of production can be improved.

### BRIEF DESCRIPTION OF THE DRAWINGS

FIG. 1A is a diagram illustrating a light irradiation apparatus used for manufacturing a photo-alignment film according to a first embodiment of the present invention;

FIG. 1B is a diagram illustrating a light irradiation apparatus without a polarizer according to the first embodiment of the present invention;

FIG. 2A is a diagram illustrating a light irradiation apparatus used for manufacturing a photo-alignment film according to a second embodiment of the present invention;

FIG. 2B is a diagram illustrating a light irradiation apparatus without a polarizer according to the second embodiment of the present invention;

FIG. 3A is a diagram illustrating a light irradiation apparatus used for manufacturing a photo-alignment film according to a third embodiment of the present invention;

FIG. 3B is a diagram illustrating a light irradiation apparatus without a polarizer according to the third embodiment of the present invention;

FIG. 4A is a diagram illustrating a light irradiation apparatus used for manufacturing a photo-alignment film according to a fourth embodiment of the present invention;

FIG. 4B is a diagram illustrating a light irradiation apparatus without a polarizer according to the fourth embodiment of the present invention;

FIG. 5 is a diagram illustrating a light irradiation apparatus in the related art; and

FIG. 6 is a diagram illustrating scan irradiation.

### DETAILED DESCRIPTION OF THE INVENTION

Embodiments of the present invention will be described with reference to the accompanying drawings. In each drawing, the same reference numerals refer to the same elements and a repeated description will be omitted.

### First Embodiment

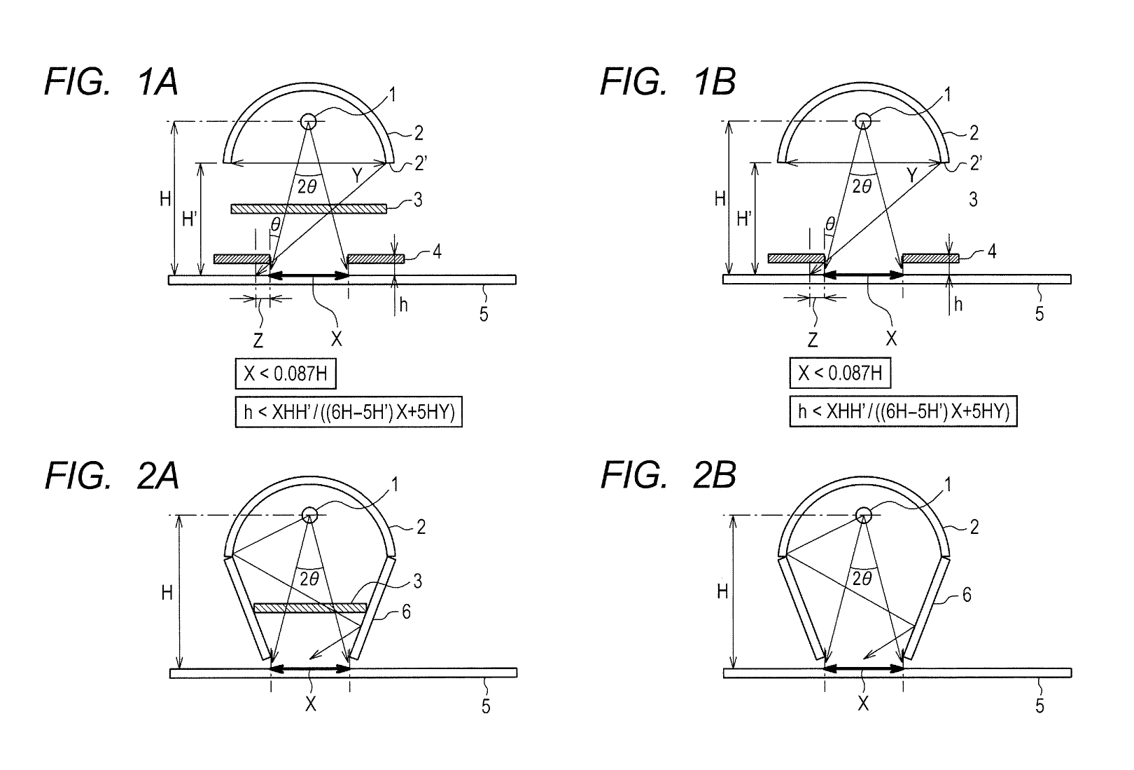

FIGS. 1A and 1B illustrate a light irradiation apparatus according to a first embodiment of the present invention. FIG. 1A illustrates the light irradiation apparatus used for manufacturing a photo-alignment film, and the like. A reflection mirror 2 is installed at an opposite side to a substrate 5 with respect to a long arc lamp 1 having the same size as the width of the substrate 5, to cover the long arc lamp 1. The long arc lamp 1 generates light such as ultraviolet rays, and the like. The cross-sectional shape of the reflection mirror 2 is an oval or parabolic shape and the reflection mirror 2 has a shape as if light irradiated from the long arc lamp 1 is condensed on the surface of the substrate. Light condensed by the reflection mirror 2 becomes light linearly polarized by a polarizer 3. Light in which the intensity of an end is weak is cut by a slit 4 placed around the substrate 5, such that the linearly polarized light is irradiated onto the substrate 5 with an unaligned polymer film (base).

In the embodiment, a divergent angle 2θ is less than 5°, that is, an angle θ at which the long arc lamp 1 is viewed up through an end of an opening of the slit 4 from the substrate is less than 2.5°, and thus a relationship between a main irradiation area length X and a gap H between the long arc lamp and the substrate on a scan-direction section satisfies the following relationship.

X<0.087H

Actually, an area to which only reflection light of the reflection mirror 2 is irradiated is present outside the length X (the length of an area directly irradiated from a lamp) of the main irradiation area defined by the divergent angle 2θ. Among them, light reflected through a reflection mirror end 2′ becomes an outermost side of the area. When the length of the area irradiated by only the reflection light is set as the length Z of a reflection light irradiation area, the length of a full irradiation area is X+2Z. In order to shorten a process time, Z as well as X needs to be unboundedly decreased. Therefore, a gap h between the slit 4 and the substrate 5 is adjusted so that Z is equal to or less than 1/10 of the length X of the main irradiation area.

When an opening width of the reflection mirror 2 is set as Y and a gap between an opening end of the reflection mirror and the substrate is set as H′, the length of the reflection light irradiation area, Z=((H−H′)X+HY)h/2H(H′−h) and when Z is 1/10 of X, that is, Z<X/10, the gap h between the slit 4 and the substrate 5 satisfies the following relationship.

h<XHH′/((6H−5H′)X+5HY

In the first embodiment, when the gap H between the long arc lamp and the substrate is set to 150 mm, the gap H′ between the opening end of the reflection mirror and the substrate is set to 110 mm, the opening width Y of the reflection mirror is set to 150 mm, θ is set to 2°, and the gap h between the slit 4 and the substrate 5 is set to 1.4 mm, the length X of the main irradiation area is 10.5 mm and the length Z of the reflection light irradiation area is 1.0 mm. When an irradiation time T is acquired by setting the length L of the substrate to 920 mm and the velocity V of the substrate to 20 mm/s, the irradiation time is 46.6 s. X in this case is 0.0698H and in order to increase a throughput, ideally, X<0.07H is preferably implemented.

Contrary to this, when θ set to 15° and the gap h between the slit 4 and the substrate 5 is set to 20 mm and other conditions are set to be the same as in the related art, the length X of the main irradiation area is 80 mm, the length Z of the reflection light irradiation area is 19 mm, and the irradiation time is 51.9 s. When θ is very small, irradiation efficiency deteriorates, and as a result, it is preferable to ensure θ of 0.25 or more.

FIG. 1B illustrates a light irradiation apparatus of FIG. 1A without the polarizer 3, which is used for manufacturing a color filter or a TFT of a liquid crystal panel. Except for presence or absence of the polarizer, the light irradiation apparatus includes the same components and shows the same effect as in FIG. 1A.

### Second Embodiment

FIGS. 2A and 2B illustrate a light irradiation apparatus according to a second embodiment of the present invention. FIG. 2A illustrates the light irradiation apparatus used for manufacturing the photo-alignment film, and the like. The reflection mirror 2 is installed at the opposite side to the substrate 5 with respect to the long arc lamp 1 having the same size as the width of the substrate 5, to cover the long arc lamp 1. The long arc lamp 1 generates light such as ultraviolet rays, and the like. The cross-sectional shape of the reflection mirror 2 is the oval or parabolic shape and the reflection mirror 2 has a shape as if light irradiated from the long arc lamp 1 is irradiated onto the surface of the substrate. Lateral reflection mirrors 6 are installed between a substrate-side section of the reflection mirror 2 and the substrate 5 at both scan-direction sides. A distance between the substrate-side sections of the two lateral reflection mirrors 6 is set as the length X of the main irradiation area. The direct light from the long arc lamp 1 or the light reflected by the reflection mirror 2 is linearly polarized by the polarizer 3, and reflected by the lateral reflection mirror 6 or directly irradiated onto the substrate surface with the unaligned polymer film (base).

Even in the embodiment, the length X of the main irradiation area and the gap H between the long arc lamp and the substrate, on a scan-direction section satisfy the following relationship.

X<0.087H

Therefore, the length X of the main irradiation area is shorter than that of the related art, the scan distance may be shortened, and the process time may be shortened.

In the second embodiment, the light from the light source is not cut by the slit but reflected by the lateral reflection mirror 6, such that almost all light may be irradiated onto the substrate surface, thereby efficiently aligning the photo-alignment film.

In the second embodiment, when the gap H between the long arc lamp and the substrate is set to 150 mm and θ is set to 2°, the length X of the main irradiation area is 10.5 mm. When the irradiation time T is acquired by setting the length L of the substrate to 920 mm and the velocity V of the substrate to 20 mm/s, the irradiation time is 46.5 s. X in this case is 0.0698H and in order to increase a throughput, ideally, X<0.07H is preferably implemented. However, when θ is very small, irradiation efficiency deteriorates, and as a result, it is preferable to ensure θ of 0.25 or more, but since a usage rate of the reflection light is higher than that of the first embodiment, θ of 0.025 or more may be ensured.

FIG. 2B illustrates a light irradiation apparatus of FIG. 2A without the polarizer 3, which is used for manufacturing the color filter or the TFT of the liquid crystal panel. Except for presence or absence of the polarizer, the light irradiation apparatus includes the same components and shows the same effect as in FIG. 2A.

### Third Embodiment

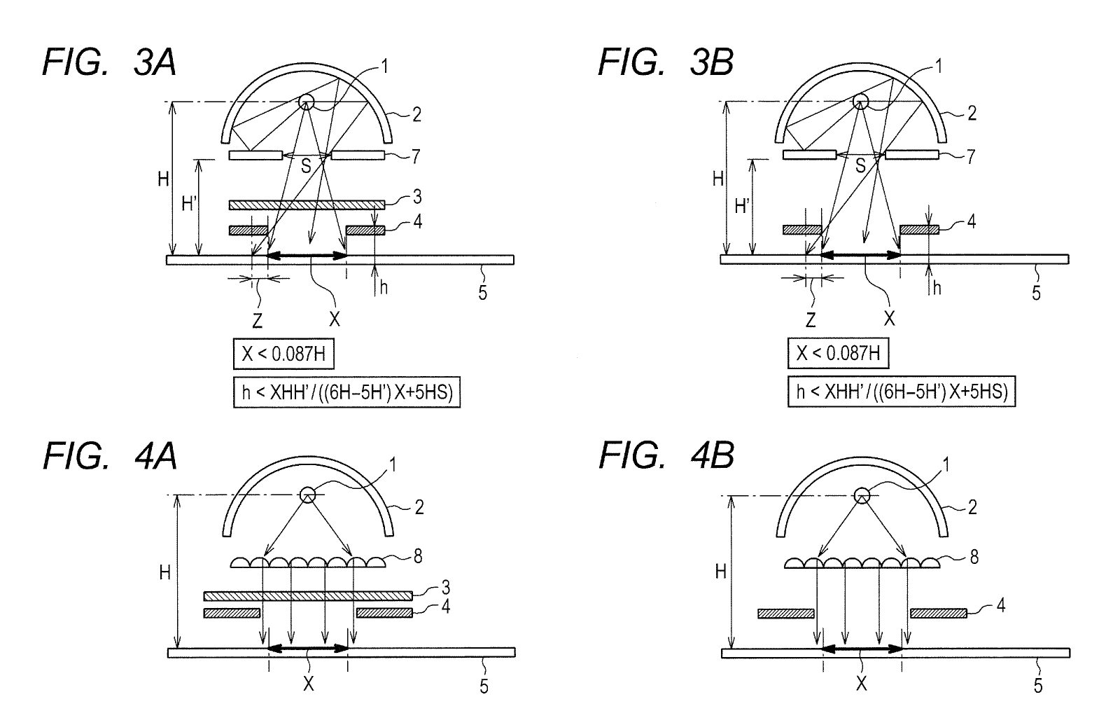

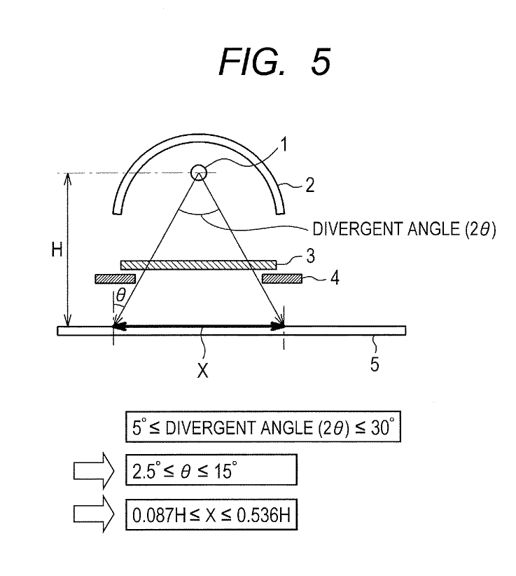

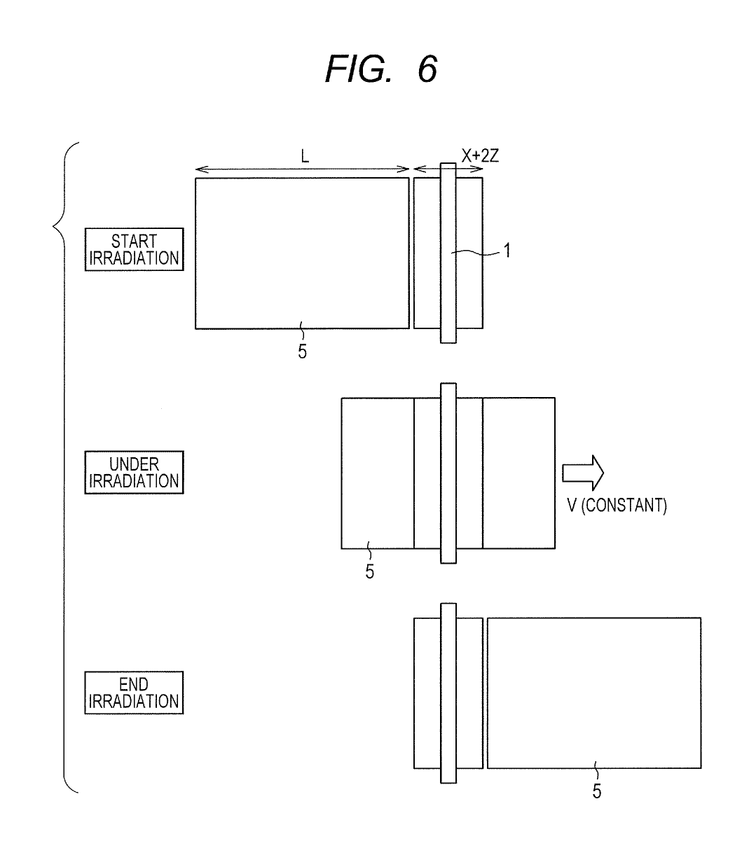

FIGS. 3A and 3B illustrate a light irradiation apparatus according to a third embodiment of the present invention. FIG. 3A illustrates the light irradiation apparatus used for manufacturing the photo-alignment film, and the like. The reflection mirror 2 is installed at the opposite side to the substrate 5 with respect to the long arc lamp 1 having the same size as the width of the substrate 5, to cover the long arc lamp 1. The long arc lamp 1 generates light such as ultraviolet rays, and the like. The cross-sectional shape of the reflection mirror 2 is the oval or parabolic shape and the reflection mirror 2 has a shape as if light irradiated from the long arc lamp 1 is irradiated onto the surface of the substrate. A mirror slit 7 having an opening is installed on the substrate-side section of the reflection mirror 2. The mirror slit 7 emits the light from the light source directly through the opening or emits the light through the opening by reflecting the light through the reflection mirror 2 and the mirror slit 7. The light from the mirror slit 7 is linearly polarized by the polarizer 3, the light in which the intensity of the end is weak is cut by the slit 4, and center light is irradiated onto the substrate surface with the unaligned polymer film (base) through the opening.

Even in the embodiment, the length X of the main irradiation area and the gap H between the long arc lamp and the substrate, on a scan-direction section satisfy the following relationship.

X<0.087H

Actually, the area to which only reflection light of the reflection mirror 2 is irradiated is present outside the main irradiation area length X (the length of the area directly irradiated from the lamp) defined by the divergent angle 2θ. Among them, light reflected through the end of the mirror slit 7 becomes the outermost side of the area. When the length of the area irradiated by only the reflection light is set as the length Z of a reflection light irradiation area, the length of a full irradiation area is X+2Z. In order to shorten a process time, Z as well as X needs to be unboundedly decreased.

Therefore, the gap h between the slit 4 and the substrate 5 is adjusted so that Z is equal to or less than 1/10 of the length X of the main irradiation area.

When an opening width of the mirror slit 7 is set as S and the gap between the opening end of the reflection mirror and the substrate is set as H′, the length of the reflection light irradiation area, Z=((H−H′)X+HS)h/2H(H′−h) and when Z is 1/10 of X, that is, Z<X/10, the gap h between the slit 4 and the substrate 5 satisfies the following relationship.

h<XHH′/((6H−5H′)X+5HS

In the third embodiment, the mirror slit 7 having the opening is installed on the substrate-side section of the reflection mirror 2. The light from the light source is reflected through the reflection mirror 2 and the mirror slit 7 to be emitted from the opening at the center of the mirror slit, such that most of light from the light source may be irradiated to the range of the length X of the main irradiation area and the optical alignment film may be efficiently aligned.

In the third embodiment, when the gap H between the long arc lamp and the substrate is set to 150 mm, the gap H′ between the opening end of the reflection mirror and the substrate is set to 110 mm, the opening width S of the mirror slit is set to 50 mm, θ is set to 2°, and the gap h between the slit 4 and the substrate 5 is set to 4 mm, the length X of the main irradiation area is 10.5 mm and the length Z of the reflection light irradiation area is 1.0 mm. When the irradiation time T is acquired by setting the length L of the substrate to 920 mm and the velocity V of the substrate to 20 mm/s, the irradiation time is 46.6 s. X in this case is 0.0698H and in order to increase the throughput, ideally, X<0.07H is preferably implemented. However, when θ is very small, irradiation efficiency deteriorates, and as a result, it is preferable to ensure θ of 0.25 or more, but since the usage rate of the reflection light is higher than that of the first embodiment, θ of 0.025 or more may be ensured.

FIG. 3B illustrates a light irradiation apparatus of FIG. 3A without the polarizer 3, which is used for manufacturing the color filter or the TFT of the liquid crystal panel. Except for presence or absence of the polarizer, the light irradiation apparatus includes the same components and shows the same effect as in FIG. 3A.

### Fourth Embodiment

FIGS. 4A and 4B illustrate a light irradiation apparatus according to a fourth embodiment of the present invention. FIG. 4A illustrates the light irradiation apparatus used for manufacturing the photo-alignment film, and the like. The reflection mirror 2 is installed at the opposite side to the substrate 5 with respect to the long arc lamp 1 having the same size as the width of the substrate 5, to cover the long arc lamp 1. The long arc lamp 1 generates light such as ultraviolet rays. The cross-sectional shape of the reflection mirror 2 is the oval or parabolic shape and the reflection mirror 2 has a shape as if light irradiated from the long arc lamp 1 is irradiated onto the surface of the substrate. A cylindrical lens 8 is installed on the substrate side of the reflection mirror 2. The cylindrical lens is formed by arranging a plurality of semi-cylindrical lenses in parallel. The divergent light from the light source or the light reflected by the reflection mirror is converted into a parallel light by the cylindrical lens 8. The light from the cylindrical lens 8 is linearly polarized by the polarizer 3 and irradiated onto the substrate surface with the unaligned polymer film (base) through the opening of the slit 4.

In the fourth embodiment, since the divergent light is converted into the parallel light by the cylindrical lens, an effective irradiation area length may be shortened.

Therefore, the irradiation area length X is shorter than that of the related art, the scan distance may be shortened, and the process time may be shortened.

In the fourth embodiment, the gap H between the long arc lamp and the substrate is set to 150 mm and the irradiation area length X is set to 10.5 mm. When the irradiation time T is acquired by setting the length L of the substrate to 920 mm and the velocity V of the substrate to 20 mm/s, the irradiation time is 46.5 s similarly as in the second embodiment.

FIG. 4B illustrates a light irradiation apparatus of FIG. 4A without the polarizer 3, which is used for manufacturing the color filter or the TFT of the liquid crystal panel. Except for presence or absence of the polarizer, the light irradiation apparatus includes the same components and shows the same effect as in FIG. 4A.

Examples of detailed numerical values of the first to fourth embodiments and comparative examples of the related art which are compared with each other will be described in Table 1 below. In this example, 51.9 s, the irradiation time T in the related art may be shortened to 46.5 to 46.6 s by setting the irradiation area length X satisfying the relationship of X<0.087H.

TABLE 1

| | Configuration | H(mm) | H′(mm) | Y(mm) | S(mm) | θ(°) | h(mm) | X(mm) | Z(mm) | L(mm) | V(mm/s) | T(s) |
|---|---|---|---|---|---|---|---|---|---|---|---|---|
| Comparative | Long arc lamp | 150 | 110 | 150 | — | 15 | 20 | 80 | 19 | 920 | 20 | 51.9 |
| example | Reflection mirror | | | | | | | | | | | |
| | Polarizer | | | | | | | | | | | |
| | Slit | | | | | | | | | | | |
| First | Comparative example + | 150 | 110 | 150 | — | 2 | 1.4 | 10.5 | 1.0 | 920 | 20 | 46.6 |
| embodiment | slit width, position change | | | | | | | | | | | |
| Second | Comparative example + | 150 | 110 | 150 | — | 2 | — | 10.5 | — | 920 | 20 | 46.5 |
| embodiment | lateral reflection mirror | | | | | | | | | | | |
| Third | Comparative example + | 150 | 110 | 150 | 50 | 2 | 4 | 10.5 | 1.0 | 920 | 20 | 46.6 |
| embodiment | mirror slit | | | | | | | | | | | |
| Fourth | Comparative example + | 150 | 110 | 150 | — | 0 | — | 10.5 | 0 | 920 | 20 | 46.5 |
| embodiment | cylindrical lens | | | | | | | | | | | |

### INDUSTRIAL APPLICABILITY

According to the present invention, by narrowing the irradiation area of light, the scan distance can be shortened and the process time can be shortened. The present invention can be used for manufacturing the photo-alignment film for the liquid crystal panel, manufacturing the phase difference film for the liquid crystal panel, manufacturing the phase difference plate attached with a pattern for a 3D liquid crystal, and all manufacturing processes that irradiate light on a large-area substrate such as the color filter or the TFT for the liquid crystal panel.

What is claimed is:

1. Alight irradiation apparatus irradiating light to a substrate by using a long arc lamp, comprising:
a reflection mirror having a cross-sectional shape which is an oval or parabolic shape and having a shape as if light irradiated is condensed on the surface of the substrate; and
a slit limiting an irradiation area of the irradiated light,
wherein on a section perpendicular to a long axis of the long arc lamp, a main irradiation area length X and a gap H between the long arc lamp and the substrate satisfy a relationship of X<0.087H, and
a gap h between the slit and the substrate satisfies a relationship of h<XHH′/((6H−5H′)X+5HY when an opening width of the reflection mirror is set as Y and the a gap between an opening end of the reflection mirror and the substrate is set as H′.

2. The light irradiation apparatus according to claim 1, further comprising: a polarizer between the long arc lamp and the substrate.

3. A light irradiation apparatus irradiating light to a substrate by using a long arc lamp, comprising:
a reflection mirror substantially controlling an irradiation direction of a light source; and
lateral reflection mirrors placed between a substrate-side section of the reflection mirror and the substrate,
wherein on a section perpendicular to a long axis of the long arc lamp, a main irradiation area length X and a gap H between the long arc lamp and the substrate satisfy a relationship of X<0.087H.

4. The light irradiation apparatus according to claim 3, further comprising: a polarizer between the long arc lamp and the substrate.

5. A light irradiation apparatus irradiating light to a substrate by using a long arc lamp, comprising:
a reflection mirror substantially controlling an irradiation direction of a light source;
a mirror slit installed on a substrate-side section of the reflection mirror and passing the light by an opening while reflecting the light; and
a slit limiting an irradiation area of the irradiated light,
wherein on a section perpendicular to a long axis of the long arc lamp, a main irradiation area length X and a gap H between the long arc lamp and the substrate satisfy a relationship of X<0.087H.

6. The light irradiation apparatus according to claim 5, further comprising: a polarizer between the long arc lamp and the substrate.

7. A light irradiation apparatus irradiating light to a substrate by using a long arc lamp, comprising:
a reflection mirror substantially controlling an irradiation direction of a light source;
a cylindrical lens collimating light on a section perpendicular to a long axis of the long arc lamp; and
a slit limiting an irradiation area of the irradiated light.

8. The light irradiation apparatus according to claim 7, further comprising: a polarizer between the long arc lamp and the substrate.
